(19) United States
(12) Patent Application Publication
(10) Pub. No.: US 2008/0294788 A1
(43) Pub. Date: Nov. 27, 2008

(54) SYSTEMS AND METHODS FOR P2P STREAMING

(75) Inventors: Kangheng Kent Wu, Yunfu City (CN); Ka Ki Terry To, Hong Kong (CN); Tak Wing Andy Lam, Hong Kong (CN); Chun Yin Trevor Ng, Hong Kong (CN)

Correspondence Address: FULBRIGHT & JAWORSKI L.L.P, 2200 ROSS AVENUE, SUITE 2800, DALLAS, TX, 75201-2784, US

(73) Assignee: Hong Kong Applied Science and Technology Research Institute Co., Ltd., Shatin (HK)

(21) Appl. No.: 11/751,525

(22) Filed: May 21, 2007

(51) Int. Cl. G06F 15/16

(52) U.S. Cl. 709/231

(57) ABSTRACT

A system for receiving content comprises: a node in a peer-to-peer (P2P) network, the node operable to receive information with regard to available media and to use the information to access streaming media content from a first source peer in the P2P network, the node further operable to use the received information to switch from the first source peer to a second source peer to access the streaming media.

### TECHNICAL FIELD

This description is related to components of Peer-to-Peer (P2P) networks and, more specifically, to components that send, receive, and/or control content in P2P networks.

### BACKGROUND OF THE INVENTION

Peer-to-Peer (P2P) networks are currently proliferating and making content available both legally and illegally. As broadband Internet access becomes more widespread, it is expected that the use of P2P networks will become widespread as well.

Recent developments have made P2P television available for consumer use. Modules known as P2P television units are beginning to make it to market. P2P television units generally receive a signal from a television source (e.g., airwaves, cable, etc.) and output a media stream, usually over Internet Protocol (IP). P2P television units are usually utilized to stream the media over a Local Area Network (LAN) to a user's digital devices that are on the LAN.

Currently, P2P television units distribute content in a point-to-point manner to one or two devices on a network. Further, these units are generally not able to communicate outside of the network. This leads to a scalability problem-users are not able to stream to a large number of devices, nor are they able to receive content from a large number of devices. It should also be noted that consumer P2P television units are unstable (i.e., likely to be powered off at unpredictable times, making their reliability questionable), such that attempts to share content therebetween often are abandoned due to problems with reliability and architecture.

Currently, there are no systems on the market that provide P2P content from a number of sources in a number of networks with a high degree of reliability.

### BRIEF SUMMARY OF THE INVENTION

Various embodiments of the present invention are directed to systems and methods for providing media content over P2P networks such that a given node has access to multiple sources of the same content. For example, some embodiments include a server that updates a database of available content from a plurality of sources in a plurality of P2P networks. A requesting node can receive a list of sources providing the content. The requesting node can then select among the sources based on, e.g., performance criteria. If a streaming session falls below a performance threshold, the requesting node can use the information in the received list to access another source, even if the other source is in another P2P network.

The database can be updated as various times, including when new sources are powered on, when sources are powered off, periodically, and/or when available content for any of the sources changes. The nodes that receive the content can query the server at various times too—at power on, when a user requests content, when performance of one source falls to an unacceptable level, and/or the like.

In some embodiments, the multiple P2P network functionality can be integral to a device along with the streaming functionality. For example, a P2P television unit can include functional units therein that communicate with a server to provide information about its content availability and to receive information about content availability of other units, even in other networks. In other embodiments, the multiple P2P network functionality can be separate from the streaming functionality, thereby adding new functionality to legacy devices.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of an exemplary system adapted according to one embodiment of the present invention;

FIG. 2 is an illustration of an exemplary system adapted according to one embodiment of the invention;

FIG. 3 is an illustration of an exemplary system adapted according to one embodiment of the invention;

FIG. 4 is an illustration of an exemplary method adapted according to one embodiment of the invention;

FIG. 5 is an illustration of an exemplary method adapted according to one embodiment of the invention;

FIG. 6 is an illustration of an exemplary method adapted according to one embodiment of the invention;

FIG. 7 is an illustration of an exemplary method adapted according to one embodiment of the invention;

FIG. 8 is an illustration of an exemplary system adapted according to one embodiment of the invention; and

FIG. 9 is an illustration of an exemplary system adapted according to one embodiment of the invention.

### DETAILED DESCRIPTION OF THE INVENTION

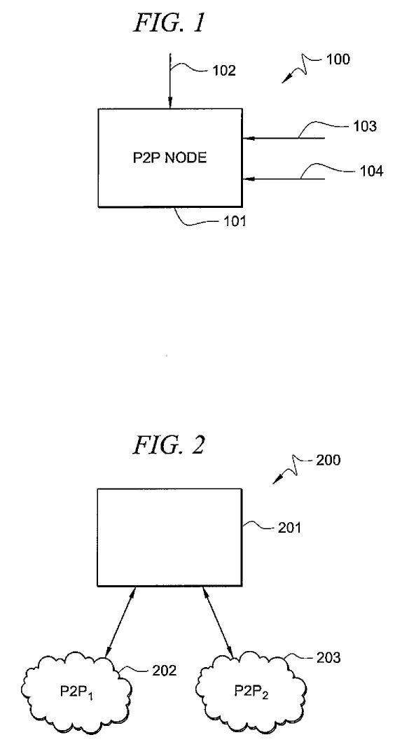

FIG. 1 is an illustration of exemplary system 100 adapted according to one embodiment of the present invention. System 100 includes Peer-to-Peer (P2P) node 101, which is operable to receive content from peers in its particular network and from peers in other networks. An example of a P2P network is a Local Area Network (LAN) with a streaming source therein and multiple nodes therein operable to receive the content and to pass it on to other peer nodes. Other examples include groups of nodes on a larger network, such as the Internet, that share content amongst each other. Node 101 may receive any kind of content, including, but not limited to, multimedia streaming content, file downloads, and the like.

Node 101, in this example, is operable to receive information 102 that includes a list of a plurality of streaming sources for particular content. In one example, information 102 includes a list of sources, their network addresses (e.g., Internet Protocol addresses), their ports, and their available streams and downloadable files. In this example, node 101 uses information 102 to display a list of available content to a user and to connect to a source after a selection by a user. Thus, node 101 may establish a streaming connection with a source to receive stream 103.

Further, in this example, node 101 uses information 102 to establish a connection to another source to receive stream 104. In one scenario, node 101 switches from stream 103 to stream 104 when the quality of stream 103 falls below a threshold or if stream 103 “freezes.” In another scenario, node 101 receives streams 103 and 104 at the same time,

Node 101 may include any of a variety of processor-based devices, such as a personal computer, a Personal Digital Assistant (PDA), a cell phone, a P2P television unit that provides a stream of a received television signal, and/or the like.

FIG. 2 is an illustration of exemplary system 200 adapted according to one embodiment of the invention. System 200 includes server 201, which is operable to communicate with various nodes in P2P networks 202 and 203.

In one aspect, exemplary server 201 contacts (or is contacted by) the various source nodes in networks 202 and 203 and creates a database of sources and their available content. Nodes in networks 202 and 203 contact server 201 and receive all or a subset of that information. For example, a node may receive a list that identifies multiple sources offering same streaming content. The node can then use the information to switch between the sources or to receive multiple streams of the same content, as described above with regard to FIG. 1.

Server 201 may include a variety of processor-based devices. Many embodiments utilize a personal computer or more powerful multi-processor computer with a high bandwidth capability for server 201.

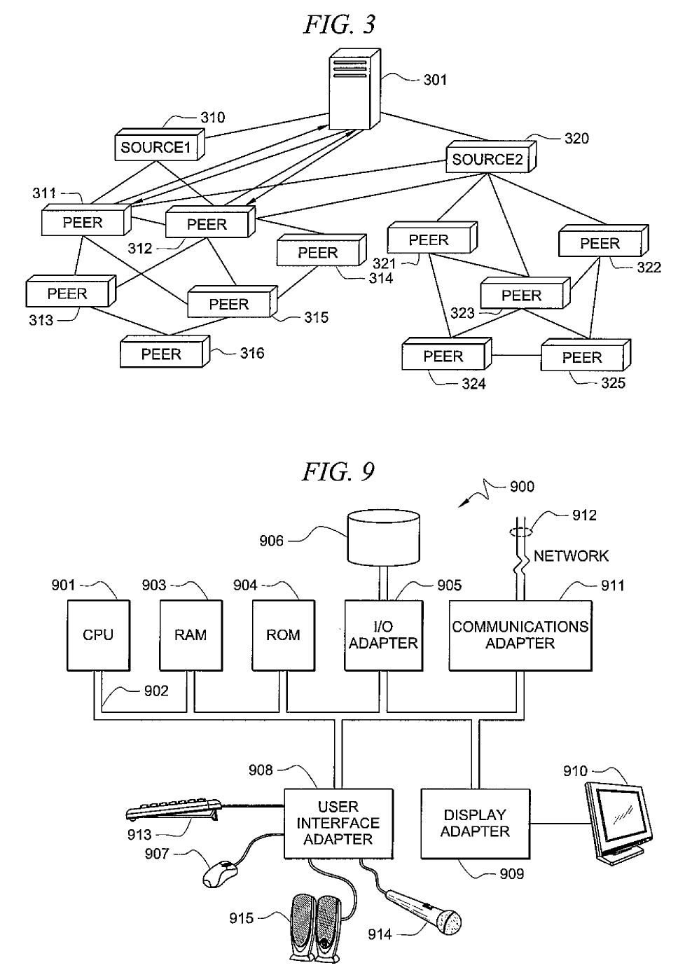

FIG. 3 is an illustration of exemplary system 300 adapted according to one embodiment of the invention. System 300 includes server 301, which may be the same as or similar to server 201 (FIG. 2) in some embodiments. System 300 further includes peer nodes 310-316 and 320-325, which may be the same as or similar to node 101 (FIG. 1).

In this example, nodes 310-316 are in one P2P network, and nodes 320-325 are in another P2P network. Each of the P2P networks shown in FIG. 3 can be considered to be an overlay-a group of peers served by a single source peer. While nodes 311-316 are not source nodes, they are operable to receive content from source node 310 and to forward that content to other nodes in the overlay. The same is true for nodes 321-325.

In some example embodiments, source nodes 310 and 320 include P2P television units that receive television signals and stream the content therefrom. However, various embodiments may use any kind of source peer and stream any kind of content, whether television-originated or otherwise.

In system 300, sources 310 and 320 send information to server 301 indicating their contacting information (e.g., network addresses and ports) and their available content. Sources 310 and 320 may send the information at power-up, periodically, when the information changes, whenever they are contacted by server 301, and/or at any other time.

Sources 311 and 312 are also in contact with server 301 to receive and cache information regarding available sources and content. In system 300, server 301 sends information to nodes 311 and 312 indicating multiple sources providing the same streaming content. Sources 311 and 312 may contact server 301 periodically, when they power up or join a network, when content is requested by a user, when performance of a given stream falls below a threshold, and/or the like.

Each of nodes 311 and 312 (or, in some embodiments, the users thereof) may choose from among the available sources. In system 300, nodes 311 and 312 receive content from source 310 as well as source 320, which is in another overlay.

It can be useful to think of nodes 311 and 312 as being in a multiple network level because they can each receive content from outside their specific P2P network. Likewise, server 301 and sources 310 and 320 are also in a multiple network level because they can communicate with nodes in more than one network. Further, nodes 310, 311, 312, and 320 along with server 301 act as a bridge between the two P2P networks shown in FIG. 3.

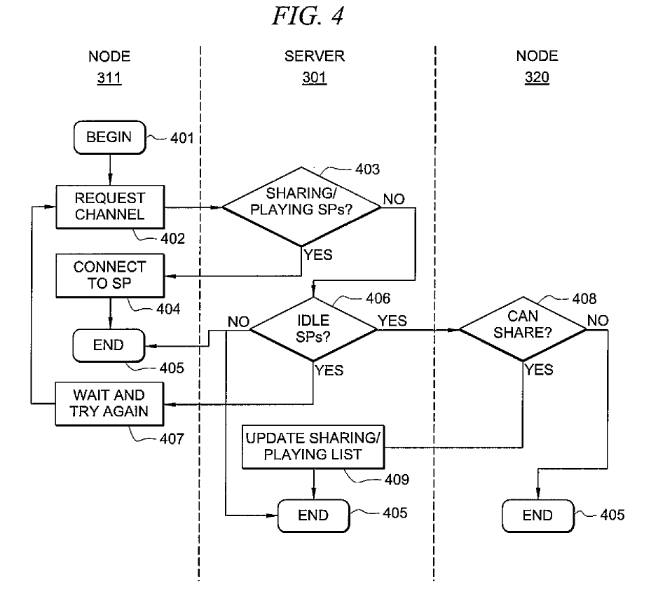

FIG. 4 is an illustration of exemplary method 400 adapted according to one embodiment of the invention. FIG. 4 shows interaction among node 311, node 320, and server 301 (all of FIG. 3). The communication among node 311, node 320, and server 301 may be over any kind of network, such as the Internet, or LAN, e.g., using Internet Protocol (IP) to send and receive packets. Internet file downloads may be performed according to one or more protocols over IP, such as File Transfer Protocol (FTP) and Hyper Text Transfer Protocol (HTTP). Internet streaming may be performed according to one or more protocols over IP, such as User Datagram Protocol (JDP) and Real Time Protocol (RTP) on top of UDP. However, the invention is not limited to communication over the Internet, as other kinds of networks, such as a cellular telephone network, a cable television network, and/or the like, may be used in some embodiments.

Method 400 begins at step 401, which progresses to step 402 wherein node 311 requests a channel from server 301. The request may be in response to a user request for content or may be automatically generated according to one or more criteria, such as a calendar or a determination that one or more other streams do not meet performance requirements.

In step 403, server 301 queries its own database to determine if there are source peers (SPs) currently sharing the content in the form of streams and/or downloads. If sources are available, server 301 provides node 311 with a list of the sources, their content, and contact information (e.g., network address, port, file name, and/or the like). Node 311 then uses that information in step 404 to connect to source 320 (assuming, of course, that source 320 is on the list). The process ends at 405.

In step 403, method 400 diverges into two scenarios. The first scenario is discussed above wherein it is determined that source 320 is sharing content. In the other scenario, the database of server 301 indicates that there are no sources currently sharing or playing the requested content, and server 301 looks for sources that are currently idle by, e.g., polling known sources in step 406. If there are idle sources, then server 301 sends a message to node 311 to wait and try again in step 407. Continuing with this example, if server 301 discovers that node 320 is idle, server 301 sends a message to node 320 asking if node 320 is available to share content in step 408. If the answer is no, the process 400 ends at step 405.

If the answer is yes, then server 301 updates its database in step 409 and ends the process in step 405. When node 311 tries again in step 402, it will receive information that node 320 is available for providing content and connect to source 320 in step 404.

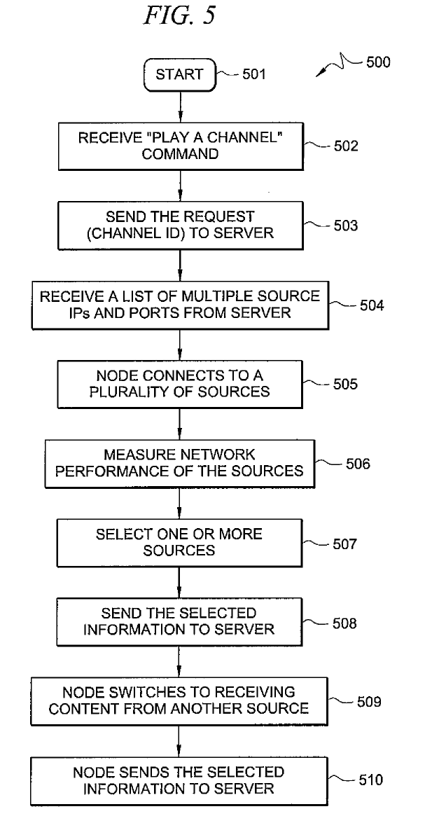

FIG. 5 is an illustration of exemplary method 500 adapted according to one embodiment of the invention. Method 500 may be performed by a receiving peer node, such as node 311 of FIG. 3, as it accesses content and forwards the content on to other nodes in its P2P network.

Method 500 beings at step 501 and progresses to step 502 wherein in it receives a “play a channel” command. The command may come manually from a user or automatically, e.g., from a scheduling program.

In step 503, the node sends a request to a server (e.g., server 301 of FIG. 3). In embodiments that employ P2P television streaming, the request that is sent may include a unique identifier of the content, such as a channel identifier or a program name identifier. Other kinds of content may also be requested using appropriate identifiers, such as file names.

In step 504, the node receives a list of multiple sources providing the same streaming content. In some embodiments, the list includes the network addresses (e.g., IP addresses) and ports of the various sources.

In step 505, the node connects to a plurality of sources indicated in the received list. The node can connect to the sources one-at-a-time or at the same time, depending on the capabilities of the node.

In step 506, the node measures the network performance of the sources. Measurable criteria include, e.g., latency, history, and packet transfer success rate. Latency represents the amount of time it takes a packet to travel in a round-trip. History includes evaluations about sources in the past, such as the online time and network bandwidth.

In step 507, the node selects one or more of the sources based on the network performance measured in step 506. In some embodiments, the node selects one or more “best” sources based on weighting of the measured criteria or other algorithm.

In step 508, the node sends the selected information to server 301. For example, the node may forward information to server 301 regarding the availability of the content and then provide the content to requesting nodes or it may simply begin streaming the content.

In step 509, the node switches to another source. In some embodiments, the node continues to measure the performance of the selected source and then switches to another source if the measured performance falls below a threshold. In another embodiment, a user prompts the node to switch to another source. Although not shown, step 509 may branch back to step 503 so that the node requests a new list of content/sources. In method 500, the node offers same streaming content from a plurality of sources and can minimize disruptions (e.g., “freezing” and other non-optimal performance) by switching between those sources.

In step 510, the node sends the new, selected information to server 301 regarding the availability of the content. The node then provides the content to requesting nodes or it may simply begin streaming the content to its P2P network.

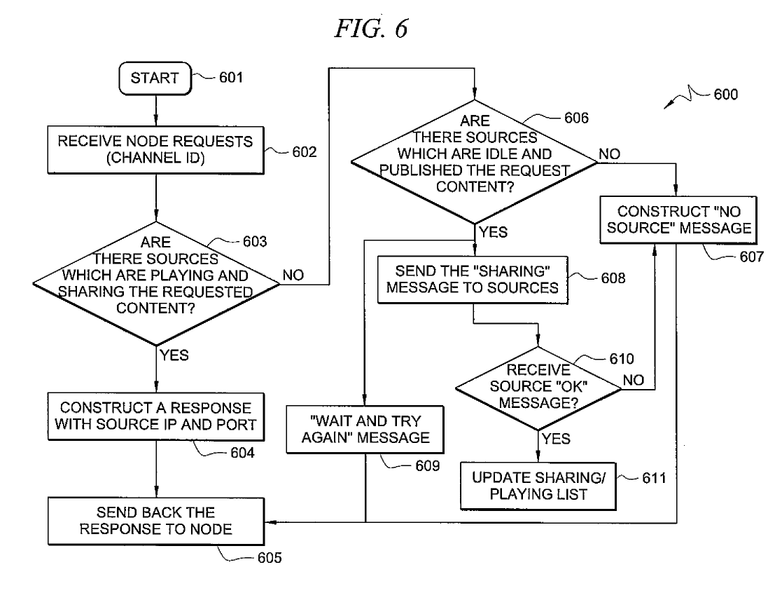

FIG. 6 is an illustration of exemplary method 600 adapted according to one embodiment of the invention. Method 600 may be performed by a server, such as server 301 of FIG. 3.

Method 600 begins at step 601 and progresses to step 602 wherein the server receives a request from a node. The request may include a channel identification, a program identification, a file name, and/or the like.

In step 603, the server checks if there are any sources playing (i.e., streaming) and sharing the requested content. If the answer is yes, then the server constructs a list in step 604. The list may include any of a variety of information regarding the available sources, including contact information, such as network address and port.

In step 605, the server sends a response to the node, including the constructed list. In this manner, the node is provided with a list of multiple sources providing same streaming content.

If the result of step 603 is no, then method 600 progresses to step 606, wherein the server determines if there are idle sources that have published the requested content. If the result of step 606 is no, then the server sends the node a “no source” message in step 607.

If the result of step 606 is yes, then the server sends a message to the identified idle source to inquire if the source will share the content in step 608 and sends a “wait and try again” message to the requesting node in step 609.

In step 610, the server looks for a response to the sharing request of step 608. If there is a positive response to the request, then the server updates the sharing/playing list in step 611. The requesting node will receive an updated list when it tries again. If there is not a positive response to the sharing request, then the server sends a “no source” message to the requesting node in step 607.

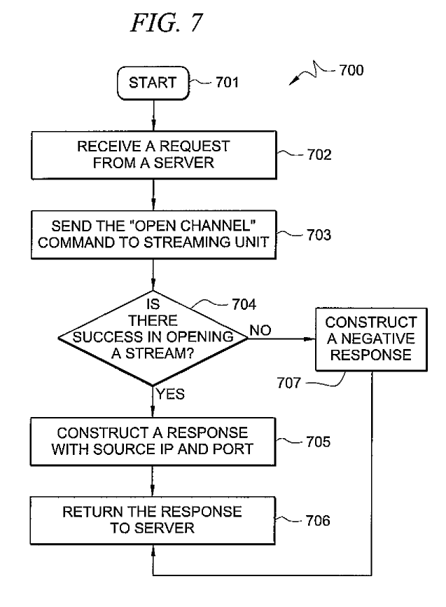

FIG. 7 is an illustration of exemplary method 700 adapted according to one embodiment of the invention. Method 700 may be performed, for example, by a source node, such as source node 320 in FIG. 3. Method 700 may be performed when a source peer is identified as an idle source by a server and can share its content.

Method 700 begins at step 701 and progresses to step 702, wherein the source node receives a request from a server. In step 703, the source node sends an open channel command to its streaming unit.

In step 704, the source node determines whether its streaming unit has had success in opening a stream. If there is not success, then the source node constructs a negative message in step 707 and sends the message to the server in step 706. If there is success in opening the stream, then the source constructs a response in step 705, the response including information regarding the source (e.g., network address, port, and/or the like) and sends the response in step 706.

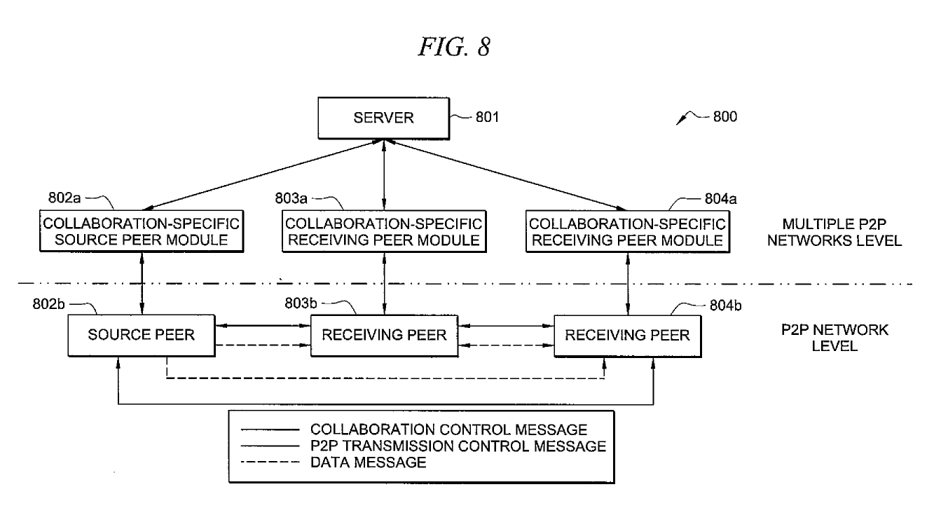

FIG. 8 is an illustration of exemplary system 800 adapted according to one embodiment of the invention. System 800 includes server 801, which is similar to server 301 of FIG. 3. Server 801 is in communication with collaboration-specific source peer module 802a and collaboration-specific receive peer modules 803a and 804a. Modules 802a, 803a, and 804a are in a multiple P2P network level, as explained above, because they can each communicate with server 801 and learn about content on modules in other P2P networks. The function of module 802a is to communicate back and forth with server 801 (e.g., to inform server 801 of the content available on module 802b), as described above, and to control module 802b to stream to peers 803b and 804b and to peers outside the overlay. The functions of modules 803a and 804a are to communicate with server 801, as described above, and to control respective modules 803b and 804b to receive media streams from within and outside the overlay. In short, modules 802a, 803a, and 804a provide the multiple-network functionality for system 800.

System 800 also includes source peer 802b and receive peers 803b and 804b. Modules 802b, 803b, and 804b are all in the same overlay in this illustration for simplicity. The function of module 802b is to provide a media stream. The functions of modules 803b and 804b is to receive streams and to pass streams on to other modules in the overlay.

In many embodiments, modules 802a and b are included in the same device, such that control and content are provided by the same device. For example, a P2P television module may be created that includes the functionality of module 802a and is, therefore, operable to communicate with server 801 to post its address and available content and also to stream to modules in other P2P networks (not shown).

In other embodiments, modules 802a and b may be separate. For example, an embodiment of the invention includes adding module 802a to a home P2P television system to enhance the functionality of a conventional home P2P television module to send and receive streams with modules in other P2P networks and to communicate with a server (e.g., server 801). The same is true for receive peer modules 803 and 804, as the multiple-network functionality can be integral to a device or separate. In many embodiments, the multiple-network functionality is provided by software and/or firmware that can be included with a processor-based device or loaded to the device at a later time.

Embodiments of the invention can be implemented in various systems. In keeping with the example above, an embodiment of the invention can be adapted for use with P2P television streaming. P2P television streaming modules receive a television signal and output a digital stream of the television content that can be consumed by, e.g., computing devices on a network. According to one embodiment of the invention, a P2P television streaming unit includes the ability to communicate with a server (e.g., server 801 of FIG. 8) and to act as both a source peer (e.g., module 802) and a receiving peer (e.g., module 803 or 804).

Implementing the above-described functionality in consumer devices is ideal in many applications because it can be used to compensate for the fact that consumer devices are often turned on and off. Thus, if peer A is receiving a stream from peer B, and peer B is turned off, peer A can find another streaming source based on the information received from a server.

Another advantage that can be realized by many embodiments, whether P2P television or otherwise, is the ability to keep streaming content at a higher performance level. As mentioned below, streaming content can be selected based on performance criteria, and streams can be switched if a first stream's performance falls below a threshold.

Yet another advantage is that various embodiments of the present invention can provide up-to-date information to a requesting module at nearly any time during operation. For example, a receive peer can receive information about available media when it turns on, requests media, begins to switch from one source to another, periodically, and/or the like. Thus, as long as the information in the database is up-to-date, a requesting node can be aware of its media choices and to provide content to a user based on the choices.

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like). In fact, readable media can include any medium that can store or transfer information.

FIG. 9 illustrates an example computer system 900 adapted according to embodiments of the present invention. That is, computer system 900 comprises an example system on which embodiments of the present invention may be implemented (such as servers 301 and 801 of the example implementation of FIGS. 3 and 8 and any of the P2P nodes shown in the various figures). Central processing unit (CPU) 901 is coupled to system bus 902. CPU 901 may be any general purpose CPU. However, the present invention is not restricted by the architecture of CPU 901 as long as CPU 901 supports the inventive operations as described herein. CPU 901 may execute the various logical instructions according to embodiments of the present invention. For example, one or more CPUs, such as CPU 901, may execute machine-level instructions according to the exemplary operational flows described above in conjunction with FIGS. 4-7.

Computer system 900 also preferably includes random access memory (RAM) 903, which may be SRAM, DRAM, SDRAM, or the like. Computer system 900 preferably includes read-only memory (ROM) 904 which may be PROM, EPROM, EEPROM, or the like. RAM 903 and ROM 904 hold user and system data and programs, as is well known in the art.

Computer system 900 also preferably includes input/output (I/O) adapter 905, communications adapter 911, user interface adapter 908, and display adapter 909. I/O adapter 905, user interface adapter 908, and/or communications adapter 911 may, in certain embodiments, enable a user to interact with computer system 900 in order to input information, such as media selections.

I/O adapter 905 preferably connects to storage device(s) 906, such as one or more of hard drive, compact disc (CD) drive, floppy disk drive, tape drive, etc. to computer system 900. The storage devices may be utilized when RAM 903 is insufficient for the memory requirements associated with storing media data. Communications adapter 911 is preferably adapted to couple computer system 900 to network 912 (e.g., the Internet, a LAN, a cellular network, etc.). User interface adapter 908 couples user input devices, such as keyboard 913, pointing device 907, and microphone 914 and/or output devices, such as speaker(s) 915 to computer system 900. Display adapter 909 is driven by CPU 901 to control the display on display device 910 to, for example, display a choice of media or to display the media as it is played.

While FIG. 9 shows a general-purpose computer, it should be noted that the exact configuration of a portion of a system according to various embodiments may be slightly different. For example, P2P nodes according to one or more embodiments may be any kind of processor-based device, such as a cell phone, a Personal Digital Assistant, a specialized device (e.g., a stand-alone P2P television module, or a Home Media Center available from Hong Kong Applied Science and Technology Research Institute Company Limited, that streams television content), a set top box, and/or the like. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for receiving content, said system comprising:
a node in a peer-to-peer (P2P) network, said node operable to receive information with regard to available media and to use said information to access streaming media content from a first source peer in said P2P network, said node further operable to use said received information to switch from said first source peer to a second source peer to access said streaming media.

2. The system of claim 1 wherein said second source peer is in another P2P network.

3. The system of claim 1 wherein said node is operable to perform said switching based on a determination that performance from said first peer has fallen below a threshold.

4. The system of claim 1 further comprising:
a database system in communication with a plurality of P2P networks, said database system receiving information from said plurality of P2P networks indicating available content, said database system providing said information with regard to available media to said node.

5. The system of claim 4 wherein said node queries said database system periodically.

6. The system of claim 4 wherein said node queries said database system in response to a user request for media content.

7. The system of claim 4 wherein said node queries said database system in response to a determination that performance from said first peer has fallen below a threshold.

8. The system of claim 1 wherein said node is further operable to ascertain performance criteria of a plurality of media sources.

9. The system of claim 8 wherein said node is further operable to select a source from among a plurality of sources based on said ascertained performance criteria.

10. The system of claim 1 wherein said node is selected from the list consisting of:
a P2P television module;
a personal computer;
a cell phone;
a Personal Digital Assistant (PDA)
a Home Media Center; and
a set top box.

11. A system for providing content, said system comprising:
a database system receiving information indicating content available from a plurality of peer-to-peer (P2P) networks, said database system operable to use said received information to create a list of multiple sources for simultaneous streaming of same content, said database system further sending said list to one or more P2P nodes in said networks in response to requests by said P2P nodes.

12. The system of claim 11 wherein said received information is updated as new devices power-on in said plurality of P2P networks.

13. The system of claim 11 wherein said received information includes items from the list consisting of:
network addresses of nodes in said P2P networks;
ports of nodes in said P2P networks; and
identifications of media content.

14. A method for consuming streamed media, said method comprising:
requesting information regarding available media on a plurality of peer-to-peer (P2P) networks:
in response to said requesting, receiving said information regarding available media, said information including:
a list of a plurality of P2P sources providing same streaming content;
accessing said streaming content from a first one of said P2P sources in said list; and
accessing said streaming content from a second one of said P2P sources in said list.

15. The method of claim 14 wherein said accessing said streaming content from a second one of said P2P sources is performed in addition to accessing said streaming content from said first P2P source.

16. The method of claim 14 wherein said accessing said streaming content from a second one of said P2P sources comprises:
switching from said first P2P source to said second P2P source.

17. The method of claim 14 further comprising:
ascertaining one or more performance criteria of said plurality of P2P sources.

18. The method of claim 17 further comprising:
selecting said first and said second P2P sources based at least in part on said ascertained performance criteria.

19. The method of claim 17 wherein said first and said second P2P sources are in different P2P networks.

20. The method of claim 17 wherein said requesting information comprises:
contacting a server in communication with said plurality of P2P networks.

21. The method of claim 17 wherein said requesting information comprises:
contacting a server in communication with said plurality of P2P networks; and
providing information to said server regarding available media.

22. The method of claim 21 wherein said contacting said server occurs at power-on of a device performing said requesting.

23. A method for providing content, said method comprising:
receiving information regarding media content available from a plurality of peer-to-peer (P2P) networks;
in response to a request from a P2P node, creating a list of P2P sources in said P2P networks providing same streaming content; and
sending said list to said requesting P2P node.

24. The method of claim 23 further comprising:
updating said received information regarding media content.

25. The method of claim 24 further comprising:
receiving an additional request from said P2P node; and
sending an updated list of P2P sources to said P2P node.

26. The method of claim 23 wherein said creating a list of P2P sources comprises:
querying a database of available media; and
polling one or more idle source nodes to determine if requested content is available therefrom.

27. A system for providing content, said system comprising:
a first peer-to-peer (P2P) network;
a second P2P network;
a database system in communication with at least one source in each of said first and second P2P networks, receiving information with regard to available media from each of said sources; and
a receiving peer in said first P2P network in communication with said database system to receive information from said database, to access streaming media content from one of said P2P networks, and to switch to receiving said streaming media content from the other of said networks, said switching facilitated by said information received from said database system.

28. The system of claim 27 wherein said receiving peer is a P2P television module, and wherein said database system stores information about available television content and accessible P2P source nodes in said first and second P2P networks.

29. The system of claim 27 wherein said receiving peer comprises and item selected from the list consisting of:
a P2P television module;
a personal computer;
a cell phone;
a Personal Digital Assistant (PDA).
